(19) United States
(12) Patent Application Publication
(10) Pub. No.: US 2026/0106274 A1
(43) Pub. Date: Apr. 16, 2026

(54) POUCH CASE FOR SECONDARY BATTERY, SECONDARY BATTERY HAVING THE SAME AND METHOD FOR MANUFACTURING THE SAME

(71) Applicant: SAMSUNG SDI CO., LTD., Yongin-si (KR)

(72) Inventors: Dong Hyun KIM, Yongin-si (KR); Ye Jin SEO, Yongin-si (KR); Eun Jeong MOON, Yongin-si (KR); Sang Gyu KIM, Yongin-si (KR); Jae Hyeon YUN, Yongin-si (KR); Jung Ah YOON, Yongin-si (KR)

(21) Appl. No.: 19/214,638

(22) Filed: May 21, 2025

(30) Foreign Application Priority Data
Oct. 16, 2024 (KR) 10-2024-0140979

(51) Int. Cl. H01M 50/126; H01M 10/0587; H01M 50/105; H01M 50/178; H01M 50/538

(52) U.S. Cl. CPC H01M 50/126; H01M 10/0587; H01M 50/105; H01M 50/178; H01M 50/538

(57) ABSTRACT

A pouch case for a secondary battery includes a pouch film including a stack of a plurality of sheet layers, the pouch film being shaped to have at least one recess, and an adhesive layer between the plurality of sheet layers, the adhesive layer being filled into at least a portion of the plurality of sheet layers.

### CROSS-REFERENCE TO RELATED APPLICATION

The present application claims priority to and the benefit of Korean Application No. 10-2024-0140979, filed on Oct. 16, 2024, in the Korean Intellectual Property Office, the entire disclosure of which is incorporated by reference herein.

### BACKGROUND

### 1. Field

Embodiments relate to a pouch case for a secondary battery, a secondary battery including the same, and a method for manufacturing the same.

### 2. Description of the Related Art

A secondary battery may include an electrode assembly including a positive electrode and a negative electrode, a case accommodating the electrode assembly, and an electrode terminal connected to the electrode assembly. Secondary batteries may be classified into circular, prismatic, and pouch types depending on their shapes. Among these, the pouch-type secondary battery may be provided as a pouch case that is modified in various shapes and has a small weight.

The above information disclosed in this Background section is for enhancement of understanding of the background of the present disclosure, and therefore, it may contain information that does not constitute related (or prior) art.

### SUMMARY

According to some embodiments, a pouch case for a secondary battery is configured to accommodate an electrode assembly for a secondary battery and an electrolyte, therein. The pouch case may be configured so that a pouch film having a shape, in which a plurality of sheet layers are stacked, has at least one recess, and an adhesive layer is interposed between the plurality of sheet layers in a manner in which the adhesive layer is filled into at least a portion of the plurality of sheet layers.

The plurality of sheet layers may include at least one insulating layer and at least one metal layer, wherein the at least one insulating layer may constitute an innermost layer that is in contact with the electrolyte.

The adhesive layer may be provided by curing a UV adhesive.

The adhesive layer may be simultaneously filled into a crack area within the lowest layer of the plurality of sheet layers and a crack area between the uppermost layers of the plurality of sheet layers.

The adhesive layer may be provided as a plurality of layers including a first adhesive layer adjacent to the outside of the pouch case and a second adhesive layer adjacent to the inside of the pouch case.

The same sheet layer may be disposed on each of both surfaces of the adhesive layer.

According to some embodiments, a secondary battery includes an electrode assembly; a pouch case configured to accommodate the electrode assembly; and an electrode tab part electrically connected to the electrode assembly and exposed to the outside of the pouch case so as to be electrically connected to the electrode assembly, wherein the pouch case is configured so that a pouch film having a shape, in which a plurality of sheet layers are stacked, has at least one recess, and an adhesive layer is interposed between the plurality of sheet layers in a manner in which the adhesive layer is filled into at least a portion of the plurality of sheet layers.

The adhesive layer may be provided by curing a UV adhesive.

The adhesive layer may be simultaneously filled into a crack area within the lowest layer of the plurality of sheet layers and a crack area between the uppermost layers of the plurality of sheet layers.

The adhesive layer may include an adhesive having a viscosity of about 15,000 cPs to about 38,000 cPs.

A surface of the adhesive layer may have a shape that protrudes more than a surface of the uppermost layer of the plurality of sheet layers of the pouch case.

The adhesive layer may include a first adhesive layer adjacent to the outside of the pouch case; and a second adhesive layer adjacent to the inside of the pouch case.

The adhesive of the first adhesive layer may have a lower viscosity than the adhesive of the second adhesive layer.

The adhesive layer may be configured to be integrally filled into a crack area passing from the lowest layer to the uppermost layer of the plurality of sheet layers.

According to some embodiments, a method for manufacturing a secondary battery, which includes an electrode assembly, a pouch case configured to accommodate the electrode assembly, and an electrode tab part electrically connected to the electrode assembly and exposed to the outside of the pouch case so as to be electrically connected to the electrode assembly, includes: manufacturing the pouch case that accommodates the electrode assembly, wherein the manufacturing of the pouch case includes performing crack inspection after allowing a forming punch to descend if at least one of a first pouch or a second pouch is formed, wherein the pouch case includes the first pouch and a second pouch that is in contact with the first pouch.

The performing of the crack inspection may include identifying coordinates of cracks occurring in the plurality of sheet layers within the pouch.

A UV adhesive may be filled from an upper side at the coordinates of the cracks.

The crack inspection may be performed by irradiating light after dark.

The method may further include a UV adhesive curing process after the performing of the crack inspection.

The UV adhesive curing process may include a curing process of curing a UV adhesive from the outside of the pouch case; and curing process of curing the UV adhesive from the inside of the pouch case.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a schematic perspective view of a pouch-type secondary battery before folding and sealing a pouch case according to embodiments;

FIG. 2 illustrates a schematic perspective view of the pouch-type secondary battery after sealing the pouch case of the secondary battery of FIG. 1;

FIG. 3 illustrates a schematic view of a forming process of manufacturing a pouch film in the form of a pouch case;

FIG. 4 illustrates a schematic view of cracks occurring when a recess depth of the pouch case is deep;

FIG. 5 illustrates a schematic cross-sectional view of a pouch film at a point at which leakage of an electrolyte occurs;

FIG. 6 illustrates a cross-sectional view of a state in which cracks of the pouch film of FIG. 5 are repaired;

FIGS. 7 to 9 illustrate schematic cross-sectional views of a state in which cracks of the pouch film are repaired according to embodiments;

FIGS. 10A to 10D illustrate a schematic view of a process of providing an adhesive layer to the pouch case after the process of manufacturing the pouch case, which is schematically illustrated in FIG. 3;

FIGS. 11 and 12 illustrate a perspective view of a battery pack to which the secondary battery is applied according to embodiments; and

FIGS. 13 and 14 illustrate perspective and side views of a vehicle including the battery pack according to embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will also be understood that when a layer is referred to as being “between” two layers, it can be the only layer between the two layers, or one or more intervening layers may also be present.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

According to a pouch-type secondary battery and a method for manufacturing the same according to embodiments, limitations such as leakage of an electrolyte and short circuit of the pouch, which are caused by cracks of a pouch case may be prevented to improve reliability of a product.

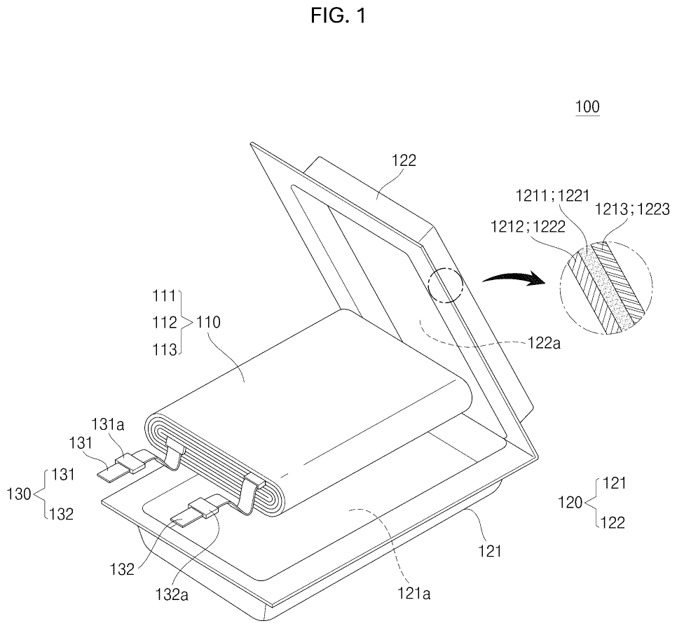

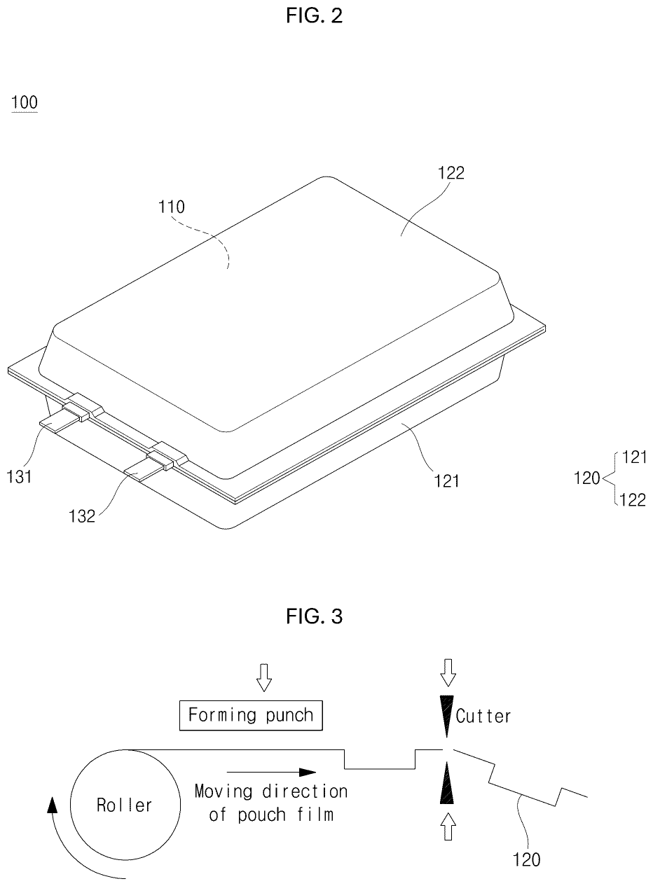

FIG. 1 illustrates a schematic perspective view of a pouch-type secondary battery 100 before folding and sealing a pouch case according to embodiments, and FIG. 2 illustrates a schematic perspective view of the pouch-type secondary battery 100 after sealing the pouch case of the secondary battery of FIG. 1.

Referring to FIGS. 1 and 2, the secondary battery 100 may include an electrode assembly 110, a pouch case 120, and an electrode tab part 130. The electrode assembly 110 may include a negative electrode plate 111, a positive electrode plate 112, and a separator 113 interposed between the negative electrode plate 111 and the positive electrode plate 112. The electrode assembly 110 may have a shape, in which the negative electrode plate 111, the separator 113, and the positive electrode plate 112 are provided in a stacked form or are wound in a jelly-roll form. In some embodiments, the electrode assembly may be accommodated in the pouch case together with the electrolyte.

The negative electrode plate 111 may include, e.g., a negative electrode active material layer applied to both surfaces of a negative electrode current collector plate made of a conductive metal plate, e.g., coper or nickel foil or mesh.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

For example, a substantially flat negative electrode tab 131 may be fixed (e.g., welded) to a negative electrode non-coating portion on which the negative electrode active material layer is not disposed on the negative electrode current plate. That is, one end of the negative electrode tab 131 may be electrically connected to the negative electrode non-coating portion, and the other end may protrude and extend to the outside. In some embodiments, an insulating member 131a may be attached to the negative electrode tab 131 to prevent the negative electrode tab from being short-circuited with the pouch case.

The positive electrode plate 112 may include, e.g., a positive electrode active material layer applied to both surfaces of a positive electrode current collector plate made of a metal sheet with excellent conductivity, e.g., aluminum foil or mesh.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L1_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt% to about 99.5 wt% on the basis of 100 wt% of the positive electrode active material layer, and the content of the binder and the conductive material is in a range of about 0.5 wt% to about 5 wt%, respectively, on the basis of 100 wt% of the positive electrode active material layer.

For example, a positive electrode tab 132 may be fixed (e.g., welded) to the positive electrode non-coating portion on which the positive electrode active material layer is not disposed on the positive electrode collector plate. In some embodiments, an insulating member 132a may be attached to the positive electrode tab 132 to prevent the positive electrode tab 132 from being short-circuited with the pouch case.

The separator 113 may be interposed between the negative electrode plate 111 and the positive electrode plate 112 to prevent the negative electrode plate and the positive electrode plate from being electrically short-circuited with each other. In practice, the separator 113 may be provided in a pair and may have a shape in which the negative electrode plate 111 is sandwiched between the pair of separators 113. In some embodiments, the separator 113 may be made of, e.g., one selected from polyethylene, polypropylene, and a porous copolymer of polyethylene and polypropylene. The separator 113 may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator 113 may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The separator 113 may be provided to have a wider width than each of the negative electrode plate 111 and the positive electrode plate 112 to prevent electrical shorts between the negative electrode plate 111 and the positive electrode plate 112 from occurring.

The electrode tab part 130 may include the negative electrode tab 131 and the positive electrode tab 132. The negative electrode tab 131 may be disposed at a left end of one side of the electrode assembly 110, and the positive electrode tab 132 may be disposed at a right end of one side of the electrode assembly 110 in which the negative electrode tab is provided. The electrode tab part 130 may be withdrawn to the outside through an area on which a main body and a cover of the pouch case 120 are fused. In some embodiments, the insulating members 131a and 132b, which are disposed on the negative electrode tab 131 and the positive electrode tab 132, respectively, may be sealed together with the pouch case 120. That is, the insulating members 131a and 132b may be disposed on portions at which the negative electrode tab 131 and the positive electrode tab 132 are in contact with the pouch case 120 to prevent the negative electrode tab 131 and the positive electrode tab 132 from being electrically short-circuited with the pouch case 120.

The pouch case 120 may accommodate the electrode assembly 110 and may be provided by sealing an outer circumferential surface of the electrode assembly 110. The pouch case 120 may include a main body 121 that substantially accommodates one surface of the electrode assembly 110 and a cover 122 that accommodates the other surface of the electrode assembly 110. For example, as illustrated in FIG. 1, both the main body 121 and the cover 122, which constitute the pouch case 120, may include a recess. In another example, a pouch case having a single cup shape in which only one of the main body and the cover includes the recess may be provided (e.g., the pouch case may be shaped to have a single cup shaped recess in only one of the main body and the cover). For example, the main body 121 may include a body recess 121a for accommodating one surface of the electrode assembly 110 and a portion of a side surface connected thereto, and similarly, the cover 122 may include a cover recess 122a for accommodating the other surface opposite to the one surface of the electrode assembly 110 and a portion of a side surface connected thereto. In some embodiments, if considering functions or shapes of the required secondary battery, only one of the body recess 121a and the cover recess 122a may be provided.

At least one of the main body 121 and the cover 122 may define the recess 121a or 122a, e.g., through a forming process for a pouch film having a material or structure described below. The pouch film may include, e.g., at least metal layer 1211 or 1221 and an insulating layer 1212 or 1222 disposed on, e.g., inside, the metal layer.

The metal layer 1211 or 1221 may function as a barrier layer that blocks penetration of moisture and air into the pouch. For example, a material of the metal layer may include at least one of aluminum (Al), nickel (Ni), and chromium (Cr), e.g., an aluminum layer. For example, a thickness of the metal layer may be about 30 μm to about 50 μm in consideration of processability and oxygen and moisture blocking properties. The metal layer may be surface-treated to improve adhesion to the insulating layer that is in contact with the metal layer.

The insulating layer 1212 or 1222 may be provided on, e.g., inside, the metal layer 1211 or 1221. The insulating layer 1212 or 1222 may be a layer disposed inside the pouch film so that one surface thereof is in contact with the electrolyte (e.g., the insulating layer 1212 or 1222 may be a layer between the electrolyte and the metal layer 1211 or 1221), and may be a layer having a function of sealing a cell through thermal bonding. If considering thermal adhesiveness and electrolyte resistance of the insulating layer 1212 or 1222, the insulating layer may include polyolefin or a copolymer of polyolefin. The polyolefin may be polyethylene (PE) or polypropylene (PP), e.g., the insulating layer 1212 or 1222 may be a non-stretched polypropylene layer.

In some embodiments, an additional insulating layer 1213 or 1223 disposed on an outer surface of the metal layer 1211 or 1221 may be further provided (e.g., the metal layer 1211 or 1221 may be between insulating layer 1212 or 1222 and the additional insulating layer 1213 or 1223). The additional insulating layer 1213 or 1223 may be introduced to protect the metal layer 1211 or 1221 from an impact, scratches, etc. For this function, a material that satisfies mechanical strength and moldability may be applied. For example, the additional insulating layer 1213 or 1223 may be mainly made of polyamide or a polyester film, and the additional insulating layer may also be a non-stretched polypropylene layer, like the insulating layer 1212 or 1222 disposed inside the metal layer 1211 or 1221. In some embodiments, the additional insulating layer 1213 or 1223 may be one or more selected from polyethylene terephthalate, polyethylene naphthalate, a polycarbonate film, etc.

As described above, the pouch case 120 constituting the main body 121 and the cover 122 may be provided to a multilayer or laminate structure between the insulating layer and the metal layer (e.g., the pouch case 120 may be formed of a film having a multilayer structure or a laminate structure including a plurality of layers). In some embodiments, various other fusion layers or functional layers may be added between the metal layer and the insulating layer (e.g., FIG. 5). As an example of the fusion layer introduced for bonding between the metal layer and the insulating layers, the fusion layer may be called a thermal fusion layer and have thermal adhesive properties to serve as a sealant. The fusion layer may be made of a polyurethane or polyolefin resin material, and a commonly used polyolefin resin layer may be non-stretched polypropylene. In some embodiments, the fusion layer may be made of a material selected from polyolefin resins such as chlorinated polypropylene, polyethylene, ethylene propylene copolymer, a copolymer of polyethylene and acrylic acid, and a copolymer of polypropylene and acrylic acid.

FIG. 3 illustrates a schematic view of a forming process during manufacturing of a pouch film in the form of a pouch case.

Referring to FIG. 3, a pouch film may be transferred through a rolling device (e.g., a roller) having a forming punch installed at an upper portion thereof. If the pouch film is disposed under the forming punch, the forming punch may descend toward the pouch film to perform the forming process (pouch case forming process), thereby manufacturing a shape of the main body or the cover of the pouch case. For example, referring to FIG. 3, the forming punch may descend toward the pouch film, while the pouch film moves away from the roller, to punch (e.g., to form) a cavity or a pocket in the pouch film (e.g., the recess 121a of FIG. 1) to accommodate an electrode assembly therein. In some embodiments, undesired cracks may occur inside the pouch case, e.g., during punching. For example, such cracks may be at edge portions of the pouch case.

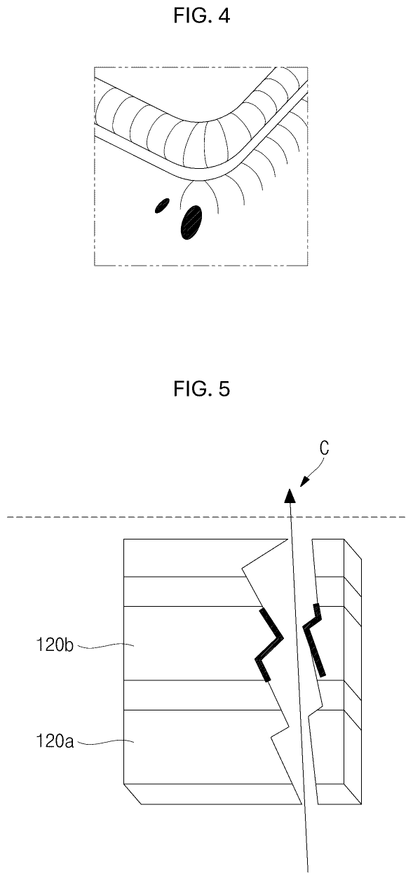

For example, the cracks may be caused due to weak strength or elongation of the material forming the pouch film, a recess depth of the pouch case that is too deep, an error in a mold design of the forming punch itself, or an error in conditions of the pouch case manufacturing process. Among these, FIG. 4 illustrates a detailed view of the cracks occurring when the recess depth of the pouch case is too deep. The inventors of the present disclosure confirmed that, during formation of a pouch case for each forming depth, wrinkles were highlighted around edges or on a flat surface of the pouch case as the forming depth gradually increased to about 2.2 mm, about 2.4 mm, and about 3.0 mm. At a forming depth of about 2.4 mm, wrinkles in the pouch case were not significantly noticeable while there was sufficient space for accommodating the electrolyte, but leakage of the electrolyte occurred at a bending part of the pouch case.

FIG. 5 illustrates a schematic cross-sectional view of the structure of the pouch film at the point at which the leakage of the electrolyte occurred in FIG. 4.

Referring to FIG. 5, if the cracks occur during the forming process in a pouch film having a stack of a plurality of layers, i.e., a metal layer 120b (e.g., an aluminum layer) outside an insulating layer 120a close to the electrode assembly (e.g., a cast polypropylene (CPP) layer), the leakage of the electrolyte inside the pouch case may occur, leading to current conduction with the metal layer 120b and short circuiting. For example, referring to FIG. 5, the pouch film may be oriented to include the insulating layer 120a between the metal layer 120b and the electrode assembly along the arrow direction of FIG. 5, with a crack area C (e.g., a crack) extending through an entire thickness of the pouch film along the arrow direction.

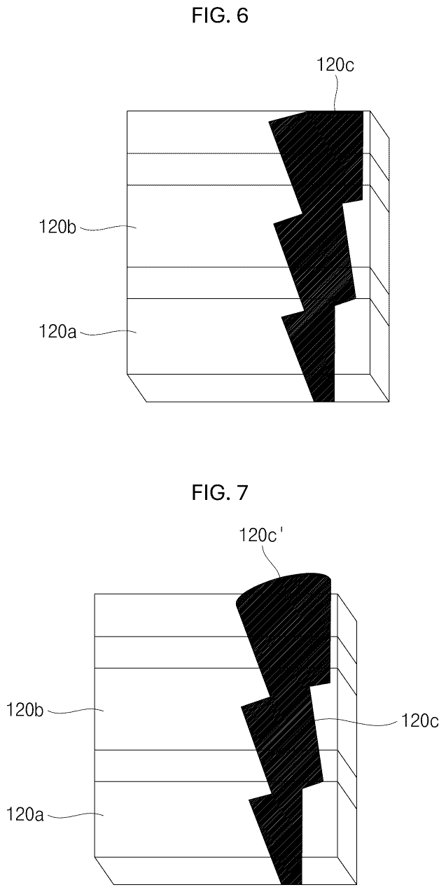

FIG. 6 illustrates a cross-sectional view of a state in which the cracks of the pouch film of FIG. 5 are repaired.

Referring to FIG. 6, it may be seen that the crack area C (FIG. 5) in which the cracks occur in the pouch film has been repaired. The pouch film may be provided in a shape in which a plurality of sheet layers are stacked, and an adhesive layer 120c passing through the plurality of sheet layers, i.e., the insulating layer 120a and the metal layer 120b, may fill (e.g., completely fill) the crack area C. For example, referring to FIG. 6, the adhesive layer 120c may pass through an entire thickness of the pouch film (e.g., through an entire thickness of each of the insulating layer 120a, the metal layer 120b, and layers therebetween along the arrow direction of FIG. 5). The adhesive layer 120c may be interposed between at least some of the plurality of sheet layers of the pouch film. The adhesive layer 120c may be interposed between the plurality of sheet layers within the pouch film after the forming process according to the manufacturing method described below. Because the adhesive layer 120c is a layer that is selectively repaired in the crack area after forming the pouch film having the plurality of sheet layers, it may be seen that the sheet layers arranged at both sides (e.g., opposite sides along a horizontal orientation in FIG. 6) of the adhesive layer 120c are made of the same material.

As may be seen in FIG. 6, the adhesive layer 120c may be filled into the crack area C, i.e., an area that becomes a passage for the electrolyte leakage due to the cracks described in FIG. 5. For example, referring to FIG. 6, an outermost surface of the adhesive layer 120c facing outside the pouch case may be coplanar (e.g., level) with an outermost surface of the pouch film. The adhesive layer 120c filled within the crack area may use a polymer that forms a photocrosslinking bond using ultraviolet (UV) rays, and may include, e.g., a UV adhesive that has been cured. If the UV adhesive, i.e. a UV-curable polymer, is used, when irradiated with the ultraviolet rays under the presence of a photoinitiator, a photopolymerization reaction may be initiated to enable photocrosslinking bonding. For this, it is desirable to select the UV-curable polymer having a property of exhibiting maximum absorbance in at least a portion of the wavelength range or the entire wavelength range of the ultraviolet light (e.g., a wavelength range of about 300 nm to about 400 nm) in an absorbance spectrum for the wavelength. Unlike the UV adhesive that forms an adhesive layer through the cross-linking by the photoinitiator, according to embodiments, non-UV adhesives may be difficult to apply (e.g., to penetrate) into an uneven portion on a surface of an edge of a crack area, or the non-UV adhesives may solidify as the adhesive material is hardened due to crystallization of the adhesive.

The UV adhesive, according to embodiments, may be made of a material containing at least one of an acrylic adhesive, a polyurethane adhesive, and an epoxy adhesive, and may have a form in which the materials are blended with each other. In some embodiments, a fluorine resin water-repellent coating agent may be additionally introduced into the UV adhesive for repairing the outermost layer of the pouch case to prevent moisture from being introduced from the outside. This may strengthen the sealing (prevention of the introduction of moisture) of the pouch case.

A viscosity of the UV adhesive may be about 15,000 cPs to about 38,000 cPs. If the viscosity is lower than about 15,000 cPs, it may be difficult to expect an effect of filling the passage for the electrolyte leakage. If the viscosity is higher than about 38,000 cPs, it may be difficult to expect an effect of being penetrated between the plurality of sheet layers. If the viscosity is in the range of about 15,000 cPs to about 38,000 cPs, sufficient fluidity may be secured so that the adhesive is easily penetrated up to the edge area of the crack area to prevent the passage for the electrolyte leakage from being blocked.

For example, referring to FIG. 7, the surface of the adhesive layer 120c may have a shape that protrudes more than a surface of the uppermost layer in the plurality of sheet layers of the pouch case. For example, a protrusion 120c′ of the adhesive layer 120c may protrude beyond (e.g., outside) the plurality of layers in the pouch film of the pouch case. The protrusion 120c′ may improve wrinkles that mainly occur on the uppermost surface during the forming process. This may be understood as an action that pulls the wrinkles of the uppermost layer of the pouch film that is in contact with both surfaces of the protrusion.

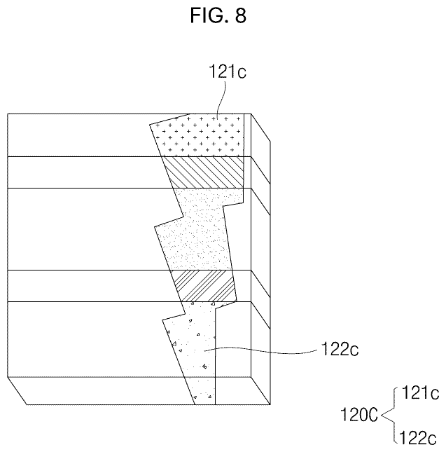

Referring to FIG. 8, the adhesive layer 120c may not be provided integrally (e.g., as a single and continuous adhesive layer) while passing through the plurality of sheet layers, but may be provided as a plurality of adhesive layers in parallel on the plurality of sheet layers. For example, referring to FIG. 8, the adhesive layer 120c may include a different adhesive layer in each of the plurality of sheet layers constituting the pouch film. For example, in some embodiments, the adhesive layer 120c may include a first adhesive layer 121c adjacent to the outside of the pouch case (e.g., an outermost layer facing an exterior of the pouch case) and a second adhesive layer 122c adjacent to the inside of the pouch case (e.g., an innermost layer facing the electrode assembly and an interior of the pouch case). The adhesive in the first adhesive layer 121c may have a lower viscosity than the adhesive in the second adhesive layer 122c. Because the adhesive in the second adhesive layer 122c has a higher viscosity than the adhesive in the first adhesive layer 121c, the leakage of the electrolyte in the area in which the electrolyte is actually disposed may be prevented more reliably. In some embodiments, those skilled in the art may differentially apply various UV adhesives depending on the degree and shape of the cracks.

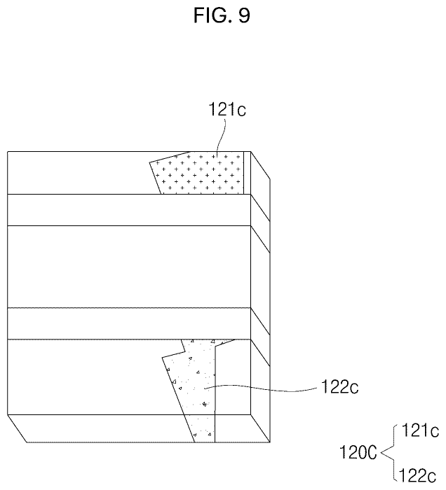

FIG. 9 illustrates a case in which the cracks occur only in some layers of the plurality of sheet layers in the pouch film, and the UV adhesive may be selectively filled only in the cracks (e.g., so a total thickness of the UV adhesive may be less than a total thickness of the pouch film when measured in the same direction). In the case in which the cracks occur only in some layers as in FIG. 9, after processes of checking the presence or absence of the crack area and identifying coordinates of the crack area described later, a degree of light leakage from the cracks may be weak due to an interference from opaque sheet layers compared to the case in which the cracks pass through all of the plurality of sheet layers. However, the presence or absence of the crack area and the coordinates of the crack area may be determined by adjusting a color difference value of a visual inspection. This may be because, if there are cracks, the thickness of the pouch film itself may be locally thinned, and light transmittance in this case may be different compared to other areas without the cracks.

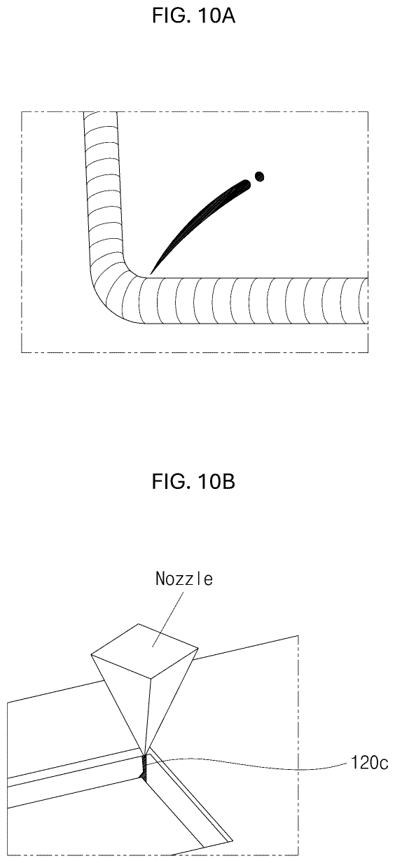

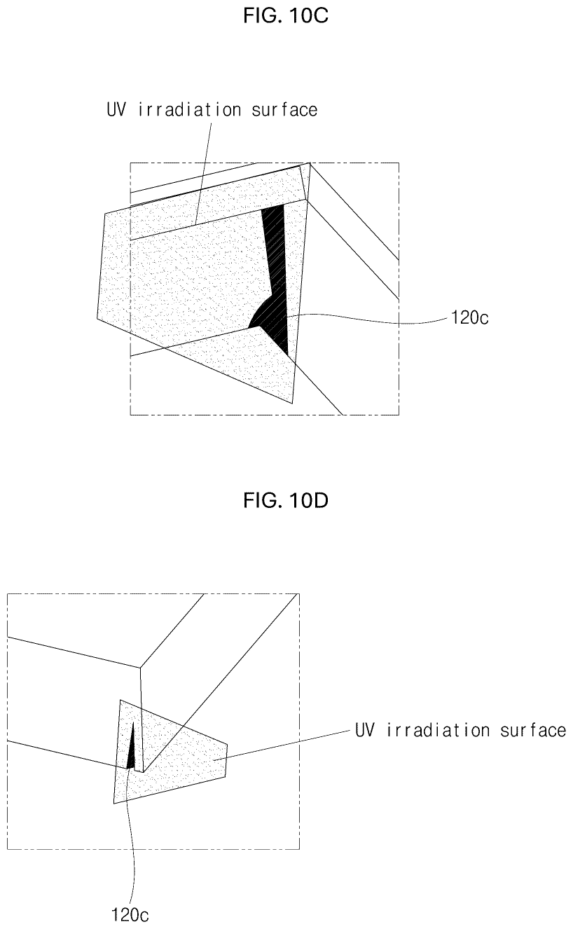

Next, a manufacturing method for providing the above-described adhesive layer 120c to the pouch film is described with reference to FIGS. 10A-10D. For convenience of explanation, detailed descriptions of stages in a method for manufacturing a pouch-type secondary battery other than formation of the adhesive layer 120c in the pouch film are omitted. That is, stages in the method for manufacturing a pouch-type secondary battery that include, e.g., processes of placing a pouch film on a mold, pressing the pouch film to be flat through a press, thereby manufacturing a pouch case, inserting an electrode assembly into a recessed space within the pouch case, sealing a main body and a cover of the pouch case after injecting an electrolyte within the pouch case, etc. are omitted.

FIGS. 10A to 10D illustrate schematic views of a process of providing an adhesive layer 120c to the pouch case after the process of manufacturing the pouch case, which is schematically illustrated in FIG. 3. This process may include a process of inspecting for a presence or an absence of a crack area and identifying coordinates of the crack area (FIG. 10A), a process of applying an adhesive to the crack area through a nozzle installed to include an adhesive so as to inject the adhesive onto the crack area identified in FIG. 10A (FIG. 10B), a process of UV irradiating the applied adhesive inside the pouch case in FIG. 10B to form a cured UV adhesive (e.g., UV curable adhesive) inside the pouch case (FIG. 10C), and irradiating the applied adhesive outside the pouch case in FIG. 10B to form a cured UV adhesive outside the pouch case (see FIG. 10D).

Referring to FIG. 10A, the process of inspecting the presence or absence of the crack area may be performed after the forming punch descends onto the pouch film to form a pouch shape (FIG. 3). The crack area inspection may visually identify the presence or absence of the crack area and the coordinates by irradiating light after dark.

Next, referring to FIG. 10B, if the crack area coordinates are identified, the UV adhesive prepared in advance may be injected into the crack area through the nozzle. Looking more closely at the UV irradiation process for the UV curing, a UV irradiation range will be applied to the entire surface on which the adhesive is determined to be applied. For example, the UV irradiation process, i.e., the UV adhesive curing process, may be performed over an intensity of about 200 W and an irradiation time of about 1 second to about 10 seconds. In some embodiments, the irradiation intensity and the irradiation time may be adjusted by those skilled in the art depending on the manufacturing purposes and environments.

In some embodiments, in the UV irradiation process for the UV curing, the curing process conditions may be differentiated between the case in which the UV irradiation process for the UV curing is performed on the applied adhesive inside the pouch case and the case in which the UV irradiation process for the UV curing is performed on the applied adhesive outside the pouch case. For example, a nozzle temperature may be within a range from room temperature to about 90° C., e.g., the nozzle temperature may be different when the irradiation process is performed internally and externally with respect to the crack area. A specific temperature may be differentiated by those skilled in the art depending on a curing agent applied to each layer. As the temperature of the nozzle varies, hardness may be appropriately maintained depending on each applied curing agent to improve material stability of the repaired adhesive layer.

According to the pouch case for the secondary battery described above, the secondary battery and the method for manufacturing the secondary battery according to the present disclosure described above, even if the strength of the pouch case is not high, or the forming depth of the pouch case is deep, the pouch-type secondary battery having the improved product reliability may be provided to improve usability in material or shape of the pouch case.

The pouch case for the secondary battery, the secondary battery, and the method for manufacturing the secondary battery according to the above-described embodiments may be applied to portable electronic devices utilizing small batteries, notebook computers, and wearable devices utilizing ultra-small batteries. In some embodiments, the pouch case for the secondary battery, the secondary battery, and the method for manufacturing the secondary battery according to the above-described embodiments may also be applied to medium-to large-sized batteries for electric vehicles using the battery pack.

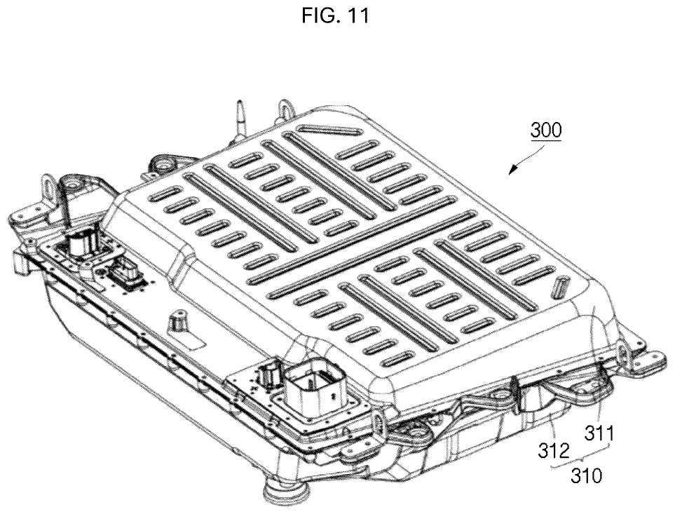

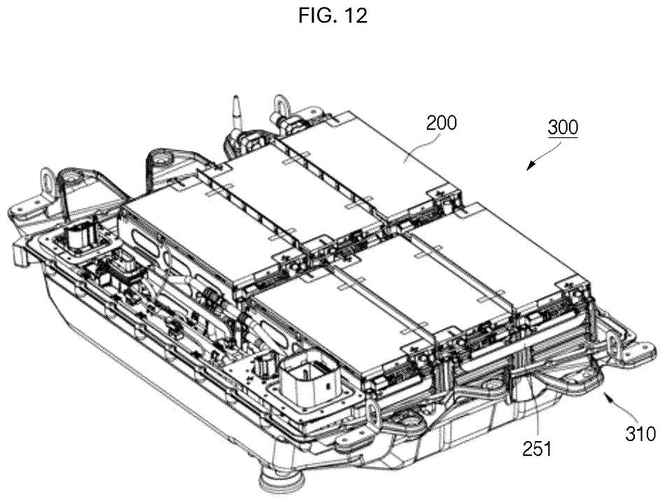

FIGS. 11 and 12 are schematic views of a configuration of a battery pack of the secondary battery according to embodiments.

Referring to FIGS. 11 and 12, a battery pack 300 according to one or more embodiments of the present disclosure may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. A vehicle may include a four-wheeled vehicle or a two-wheeled vehicle.

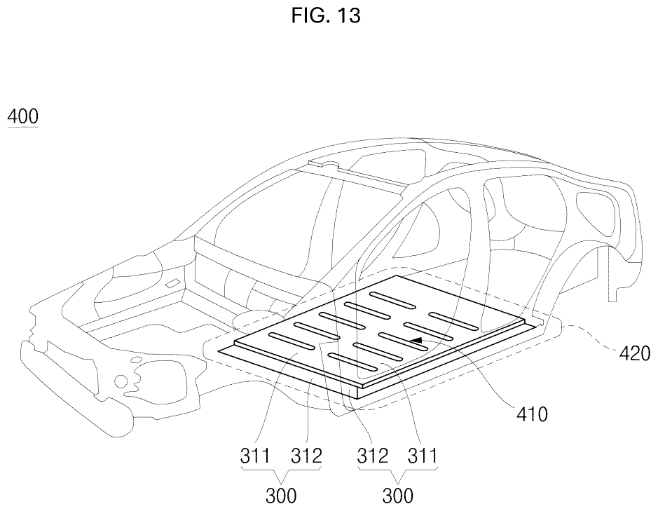

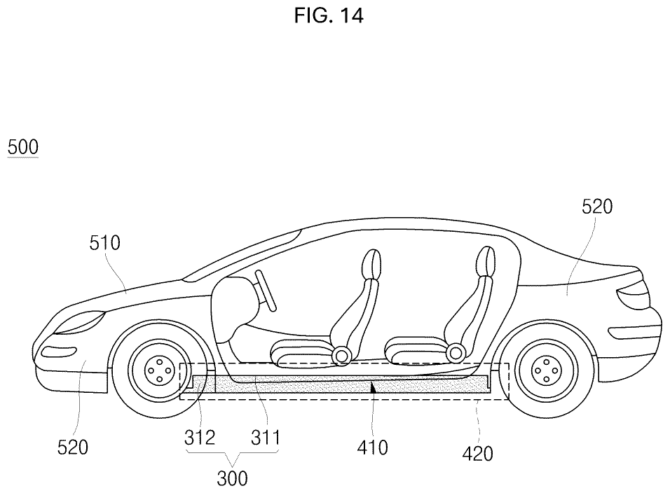

FIGS. 13 and 14 illustrate perspective and side views of vehicle body parts 400 and a vehicle 500 including the battery pack 300 shown in FIGS. 11 and 12.

In FIG. 13, the battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 14, the vehicle 500 may be formed by combining additional parts, such as a hood 510 in front of the vehicle 500 and fenders 520 respectively located in the front and rear of the vehicle 500 to a vehicle body parts 400. The vehicle 500 may include the battery pack 300 including the battery pack cover 311 and the pack frame 312, and the battery pack 300 may be coupled to the vehicle body part 400.

By way of summation and review, a pouch forming in a process for packaging a pouch-type secondary battery is a process of forming a pouch film to form a pocket portion into which the electrode assembly is placed. However, undesirable cracks in the pouch may occur, if the strength of the pouch film is weak or if the forming depth is too deep.

In contrast, aspects of some embodiments of the present disclosure provide a pouch case that prevents limitations such as leakage of an electrolyte and short circuit of a pouch, which are caused by cracks in the pouch case, from occurring to improve reliability of a product, a pouch-type secondary battery, and a method for manufacturing the same. That's is, according to the embodiments, even if the strength of the pouch case is not high, or the forming depth of the pouch case is deep, the pouch-type secondary battery having the improved reliability of the product may be provided.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is

1. A pouch case for a secondary battery, the pouch case comprising:
a pouch film including a stack of a plurality of sheet layers, the pouch film being shaped to have at least one recess; and
an adhesive layer between the plurality of sheet layers, the adhesive layer being filled into at least a portion of the plurality of sheet layers.

2. The pouch case as claimed in claim 1, wherein the plurality of sheet layers include at least one insulating layer and at least one metal layer, the at least one insulating layer constituting an innermost layer of the pouch film in contact with an electrolyte.

3. The pouch case as claimed in claim 1, wherein the adhesive layer is a UV curable adhesive.

4. The pouch case as claimed in claim 1, wherein the adhesive layer is in a crack area within an innermost layer of the plurality of sheet layers and a crack area within an outermost layer of the plurality of sheet layers.

5. The pouch case as claimed in claim 1, wherein the adhesive layer includes a first adhesive layer adjacent to the an of the pouch case and a second adhesive layer adjacent to an inside of the pouch case.

6. The pouch case as claimed in claim 1, wherein a same sheet layer of the plurality of sheet layers is on opposite surfaces of the adhesive layer.

7. A secondary battery, comprising:
an electrode assembly;
a pouch case accommodating the electrode assembly, the pouch case including:
a pouch film including a stack of a plurality of sheet layers, the pouch film being shaped to have at least one recess accommodating the electrode assembly, and
an adhesive layer between the plurality of sheet layers, the adhesive layer being filled into at least a portion of the plurality of sheet layers; and
an electrode tab part electrically connected to the electrode assembly and exposed to an outside of the pouch case.

8. The secondary battery as claimed in claim 7, wherein the adhesive layer is a UV curable adhesive.

9. The secondary battery as claimed in claim 7, wherein the adhesive layer is in a crack area within an innermost layer of the plurality of sheet layers and a crack area within an outermost layer of the plurality of sheet layers.

10. The secondary battery as claimed in claim 7, wherein the adhesive layer has a viscosity of about 15,000 cPs to about 38,000 cPs.

11. The secondary battery as claimed in claim 7, wherein an outer surface of the adhesive layer protrudes beyond an outer surface of an outermost layer of the plurality of sheet layers of the pouch case.

12. The secondary battery as claimed in claim 7, wherein the adhesive layer includes:
a first adhesive layer adjacent to the outside of the pouch case; and
a second adhesive layer adjacent to an inside of the pouch case.

13. The secondary battery as claimed in claim 12, wherein the first adhesive layer has a lower viscosity than the second adhesive layer.

14. The secondary battery as claimed in claim 7, wherein the adhesive layer continuously fills an entire crack area passing from an innermost layer to an outermost layer of the plurality of sheet layers.

15. A method for manufacturing a secondary battery, the method comprising:
forming an electrode assembly;
forming a pouch case configured to accommodate the electrode assembly; and
forming an electrode tab part electrically connected to the electrode assembly and exposed to an outside of the pouch case,
wherein forming the pouch case includes:
allowing a forming punch to descend onto a pouch film, such that a first pouch and a second pouch are formed,
performing crack inspection after forming the first pouch and the second pouch, and
assembling the first pouch and the second pouch to contact each other, with the electrode assembly therebetween.

16. The method as claimed in claim 15, wherein:
the pouch film is formed of a stack of a plurality of sheet layers, and
performing the crack inspection includes identifying coordinates of cracks occurring in the plurality of sheet layers within the pouch case.

17. The method as claimed in claim 16, wherein a UV adhesive is filled from an upper side at the coordinates of the cracks.

18. The method as claimed in claim 15, wherein performing the crack inspection includes irradiating light after dark.

19. The method as claimed in claim 15, further comprising a UV adhesive curing process, after performing the crack inspection.

20. The method as claimed in claim 19, wherein the UV adhesive curing process includes:
curing a UV adhesive from an outside of the pouch case; and
curing the UV adhesive from an inside of the pouch case.
